(19) United States
(12) Patent Application Publication
(10) Pub. No.: US 2005/0033570 A1
(43) Pub. Date: Feb. 10, 2005

(54) Method for adjusting an acoustic sequence

(76) Inventors: Frank Bachmann, Berlin (DE); Bart Baekelandt, Melle (BE); Herbert Heiss, Puchheim (DE); Werner Kober, Neuried (DE); Thierry Nedelec, Miesbach (DE); Norbert Seitter, Unterhaching (DE); Josef Weinhappl, A-Wien (DE)

Correspondence Address: MORRISON & FOERSTER LLP, 1650 TYSONS BOULEVARD, SUITE 300, MCLEAN, VA, 22102, US

(21) Appl. No.: 10/491,041

(22) PCT Filed: Sep. 26, 2001
(86) PCT No.: PCT/DE01/03715

(51) Int. Cl. G10L 21/00

(52) U.S. Cl. 704/209; 704/240

(57) ABSTRACT

Efficient adjustment of tones and announcements are equalized in the conversation of a mobile radio telephone subscriber by a common air interface (4) enabling an exchange to occur between several transmission modes characterized by different compression of said conversation. This is achieved by means of a device and a method for adjusting an acoustic sequence (11; 12; 13; 14; 15; 16; 17; 18) in the speech channel of a common air interface (4) for a subscriber (2) of a mobile radio telephone network (4, 3, 5). According to the invention, a transmission mode (A; B; C) which is to be used on the speech channel can be selected (3,5) from several transmission modes defined by differing degrees of compression of speech sequences (8) of the subscriber (2) on the common air interface. An adjustable acoustic sequence is stored in several compression data sets (11, 12, 13, 14, 15, 16, 17, 18) whose compression respectively corresponds to the compression of at least one of the transmission modes (A; B; C:). In order to adjust an acoustic sequence (11; 12; 13; 14; 15; 16; 17; 18) in the speech channel of the common air interface (4), the compression data set (11) whose compression (A) corresponds to the currently used compression (A) in the voice channel is selected from several stored compression data sets and is inserted into the voice channel.

### CLAIM FOR PRIORITY

This application claims priority to International Application No. PCT/DE01/03715, which was published in the German language on Apr. 3, 2003, which was filed in the German language on Sep. 26, 2001, the contents of which are hereby incorporated by reference.

### TECHNICAL FIELD OF THE INVENTION

The invention relates to devices and methods for adjusting an acoustic sequence, and in particular, in a speech channel of an air interface of a mobile radio network provided for a subscriber of a mobile radio network.

### BACKGROUND OF THE INVENTION

A subscriber's call is transmitted compressed (by means of an AMR codec with UMTS for example) over a speech channel of an air interface. An AMR codec includes an algorithm which for example compresses 20-msec speech samples in 8 modes to bit rates AMR-Mode 7=12.2 kbps, AMR-Mode 6=10.2 kbps, AMR-Mode 5=7.95 kbps, AMR-Mode 4=7.40 kbps, AMR-Mode 3=6.70 kbps, AMR-Mode 2=5.90 kbps, AMR-Mode 1=5.15 kbps or AMR-Mode 0=4.75 kbps.

Before a (UMTS for example) speech connection is set up, an RNC (Radio Network Controller or base station/base station controller) of a mobile radio network negotiates a set of AMR modes with a switching center via which the speech connection is to pass. During connection setup or the existing connection the RNC can request a change to the current AMR mode by deleting negotiated AMR modes. Such a change of AMR mode can thus be undertaken in the switching center during the adjustment of acoustic sequences such as tones and recorded announcements.

### SUMMARY OF THE INVENTION

The present invention enables an efficient adjustment of acoustic sequences in a call of a mobile radio subscriber over an air interface in which an switch between different transmission modes, each identified by a different compression of the call, can take place.

In accordance with one embodiment of the invention, tones and recorded announcements can be adjusted quickly, easily and efficiently during a call if the allowed transmission modes change. This means that transcoding before adjustment is not required.

An adjustable acoustic sequence is usefully stored in all selectable transmission modes so that adjustment of acoustic sequences is made easier in accordance with invention for all possible transmission modes.

The compression data records are preferably stored in a switching center of the mobile radio network over which the voice sequences of the subscriber are transmitted, from where they are easily accessible.

### BRIEF DESCRIPTION OF THE DRAWINGS

Further features and advantages of the invention are described below in the description with respect to exemplary embodiments illustrated in the drawings. The Figures show:

FIG. 1 a diagram of the transmission of speech over a speech channel of an air interface of a mobile radio network provided for a subscriber of a mobile radio network.

FIG. 2 a diagram of the insertion of an acoustic sequence (recorded announcement tones etc) into a voice connection of a mobile radio subscriber.

### DETAILED DESCRIPTION OF THE INVENTION

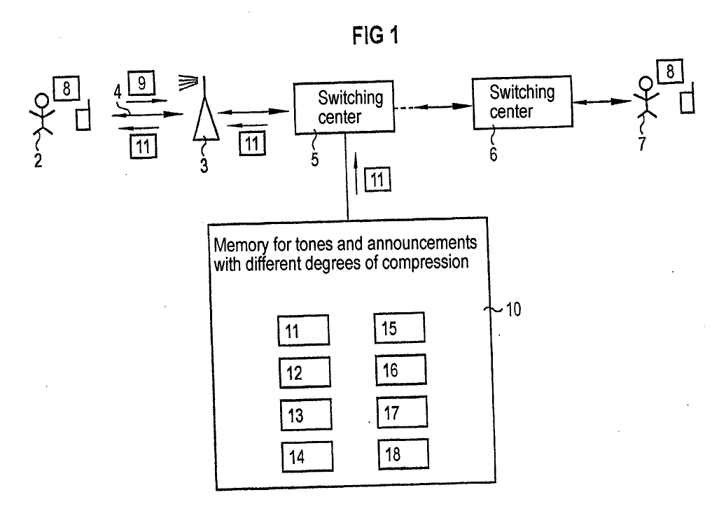

FIG. 1 shows a subscriber 2 with a mobile station, a node B (base station), an RNC 20, an air interface 4, a first switching center 5, a further switching center 6, a further node B and a further RNC, a further subscriber 7, uncompressed speech sequences 8 of the subscriber 2, compressed speech sequences 9 of the subscriber 2, a memory 10 with (at least) one acoustic sequence 11-18 stored in it as a data record (with the same speech content or tone but in different compressions of the speech content or tone) (of which one is to be sent over an air interface 4 to the subscriber 2).

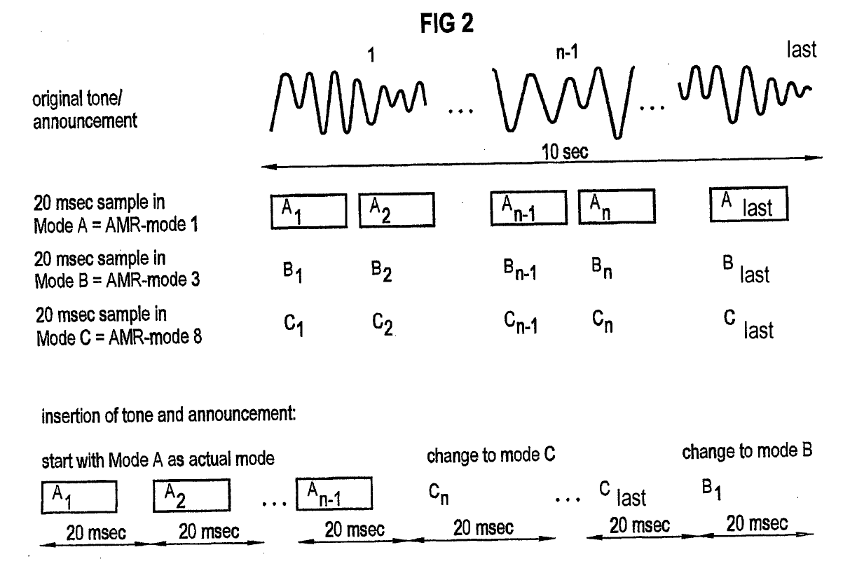

FIG. 2 shows a number of time segments (sequences “1”, “m−1”, “last”) from a tone or recorded announcement transmitted compressed over a speech channel of an air interface of a mobile radio network for adjustment for two subscribers 2, 7 of one or more telecommunication networks.

Sequence 1 is shown in a first compression (used in a first transmission mode) as data record A1 (=reference number 11 in FIG. 1), a second compression (used in a second transmission mode) as data record B1 (=reference number 13 in FIG. 1) and a third compression (used in a third transmission mode) as data record C1 (=reference number 18 in FIG. 1). The time axis is shown as an arrow in each case. Data record A1 in shorter than sequence 1, since A1 is a compression (with a known compression method, e.g. AMR) of the content of sequence 1. B1 is shorter than sequence 1 and shorter than A1 since B1 is a stronger compression of the content of the sequence 1 than A1.

C1 is shorter than sequence 1 and shorter than A1 and shorter than B1, since C1 is a stronger compression of the content of sequence 1 than A1 and B2. A stronger compression can for example be used for a higher-quality of a transmission channel and/or lower quality requirements.

In a switching center (circuit or packet switching center; MSC or media gateway etc) 20-msec speech samples 1 (time sections of the call) are converted from a for example linearized signal scanned at 8 kHz or a 11-18 A-law coded signal of a subscriber into the currently valid transmission mode (AMR mode etc) A or B or C (=transcoded).

When a speech channel is set up the (one or more) transmission modes A, B, C to be used between the RNC and a switching center for transmission of speech signals 1, 8 of the subscriber are pre-selected (negotiated), from which during the communication of the subscriber a current transmission mode A or B or C to be used (=e.g. now or at a definable point in time) is selectable.

For example 8 transmission modes (AMR mode etc) are possible, from which 3 transmission modes A, B, C (corresponding to “AMR modes 7, 5, 0” in accordance with FIG. 2) are pre-selected (negotiated). When an acoustic sequence is adjusted in a call which is currently for example using transmission mode A, announcements are adjusted into the same transmission mode A, meaning that instead of containing a time section of the subscriber's call, packet A1 includes a compressed announcement in transmission mode A. Since the (at least one) announcement is available compressed in all possible (e.g. 8) transmission modes, only that announcement (from 11-18) needs to be selected for adjustment for which the compression corresponds to the compression currently used on the speech channel (e.g. A corresponding to the AMR mode 1).

### EXAMPLE

Tones and announcements are present as for example 8 compression data records (Samples 11-18) transcoded in all 8 AMR modes in memory 10 in FIG. 1. The samples thus produced are 20 msec long in each case for example (an announcement can comprise a number of consecutive samples 11 of the same or different compression) and are stored centrally in the switching center. The number of samples per tone and announcement is the same and differs in the byte size per 20-msec sample. The RNC for example has negotiated with a switching center 5 a mode set includes the following AMR modes: Mode A=12.20 kbps with 244 bits or 31 bytes (including bit stuffing) per 20-msec speech sample

Mode A=7.95 kbps with 159 bits or 95 bytes (including bit stuffing) per 20-msec speech sample. Mode A=4.75 kbps with 75 bits or 95 bytes (including bit stuffing) per 12-msec speech sample.

When a tone or announcement is to be adjusted, the currently valid AMR mode is first determined and the associated sample with the number 11 is selected and transmitted e.g. in Mode A. Then the next sample with the number 2 and so on is sent in the same mode A in each case. After the sample N−1 in Mode A has been sent out, the RNC deletes this currently valid Mode A and Mode B from the existing mode set to initiate a change of mode. The result of this is that for transmission of the next sample N there must be a change to the next possible mode C. Therefore the sample with the number n−1 is sent from the appropriate sequence of samples (transcoded in the new Mode C to be used) for this tone or this announcement.

Since this method only requires administration of the samples to be transmitted and no ongoing transcoding from the original signal, reacting to a change of AMR mode in the switching center requires minimal effort. This method is also applicable to other codec types, especially if speech samples of the same length are only ever to be transcoded with this codec.

1. A method for adjusting an acoustic sequence in a speech channel of an air interface of a mobile radio network provided for a subscriber of a mobile radio network, comprising:
providing one transmission mode to be used on the speech channel being selectable from a number of transmission modes defined by different levels of compression of speech sequences to be transmitted of the subscriber on the air interface, and
storing an adjustable acoustic sequence being in a number of compression data records for which the compression corresponds in each case to the compression of at least one of the transmission modes, wherein
for adjusting the acoustic sequence into a speech channel of the air interface the data records of a number of the stored compression data records are selected and inserted in the speech channel for which the compressions corresponds to the current compression used in the speech channel.

2. The method in accordance with claim 1, wherein for the speech channel, a number of usable transmission modes are pre-selected in each case, from which, during communication of the subscriber of the mobile radio network with another subscriber of the mobile radio network or fixed network a transmission mode to be used currently can be selected.

3. The method in accordance with claim 1, wherein a base station controller or RNC of the mobile radio network before a speech connection is set up for the subscribers negotiates a number of transmission modes that can be selected during the speech connection with a circuit-based or packet-based switching centers of the mobile radio network.

4. The method in accordance with claim 1, wherein in a switching centers of the mobile radio network speech sequences to be transmitted over a speech channel of the air interface to the subscribers are transcoded before transmission over the air interface into the currently selected transmission mode.

5. The method in accordance with claim 1, wherein the currently selected transmission mode is the transmission mode currently used or the transmission mode with a highest transmission rate from a set of allowed transmission modes.

6. The method in accordance with claim 1, wherien an acoustic sequence that can be adjusted is stored in all selectable transmission modes.

7. The method in accordance with claim 1, wherein the speech sequences of the subscribers represent a call of the subscriber to another subscriber of a telecommunication network.

8. The method in accordance with claim 1, wherein the acoustic sequence includes a recorded announcement.

9. The method in accordance with claiom 1, wherein the acoustic sequence includes tones.

10. The method in accordance with claim 1, wherein the compression data records each represent an acoustic sequence of the same length with different bit lengths.

11. The method in accordance with claim 1, wherein the compression data records are stored in a switching center of the mobile radio network via which speech sequences of the subscribers are transmitted.

12. (Canceled)

13. A device for adjusting an acoustic sequence in a speech channel of an air interface of a mobile radio network provided for a subscriber of a mobile radio network, wherein the device provides one transmission mode to be used on the speech channel being selectable from a number of transmission modes defined by different levels of compression of speech sequences to be transmitted of the subscriber on the air interface,
stores an adjustable acoustic sequence being in a number of compression data records for which the compression corresponds in each case to the compression of at least one of the transmission modes, and
adjusts the acoustic sequence into a speech channel of the air interface, the data records of a number of the stored compression data records are selected and inserted in the speech channel for which the compression corresponds to the current compression used in the speech channel.

14. A device for adjusting an acoustic sequence into a speech channel of an air interface of a mobile radio network which can be used for a subscriber of a mobile radio network, comprising:
with first unit to select a transmission mode to be used on the speech channel of the air interface from a number of transmission modes defined by different levels of compression of speech sequences the subscriber to be transmitted and acoustic sequences on the air interface; and
a memory for a number of compression data records each representing an equivalent acoustic sequence to be adjusted in, for which compression in each case corresponds to the compression of at least one of the transmission modes of the air interface of the mobile radio network, with a second unit to adjusting an acoustic sequence into the speech channel of the air interface in the form of a compression data record from a stored selection of compression data records for which compression corresponds to the current compression being used in the speech channel.

15. A computer readable medium for execution of a program for adjusting an acoustic sequence in a speech channel of an air interface of a mobile radio network provided for a subscriber of a mobile radio network, the progarm executing the following:
providing one transmission mode to be used on the speech channel being selectable from a number of transmission modes defined by different levels of compression of speech sequences to be transmitted of the subscriber on the air interface; and
storing an adjustable acoustic sequence being in a number of compression data records for which the compression corresponds in each case to the compression of at least one of the transmission modes, wherein for adjusting the acoustic sequence into a speech channel of the air interface, the data records of a number of the stored compression data records are selected and inserted in the speech channel for which the compression corresponds to the current compression used in the speech channel.
